(19) United States
(12) Patent Application Publication
(10) Pub. No.: US 2024/0429983 A1
(43) Pub. Date: Dec. 26, 2024

(54) CHANNEL STATE INFORMATION REFERENCE SIGNAL ENHANCEMENTS FOR WIRELESS DEVICES

(71) Applicant: Telefonaktiebolaget LM Ericsson (publ), Stockholm (SE)

(72) Inventors: Ryan PADERNA, Yokohama, Kanagawa (JP); Ilmiawan SHUBHI, Malmö (SE); Sina MALEKI, Malmö (SE); Andres REIAL, Höllviken (SE); Ali NADER, Malmö (SE); Niklas ANDGART, Södra Sandby (SE)

(21) Appl. No.: 18/686,196

(22) PCT Filed: Aug. 30, 2022
(86) PCT No.: PCT/EP2022/074065

§ 371 Date: Feb. 23, 2024

Related U.S. Application Data
(60) Provisional application No. 63/238,598, filed on Aug. 30, 2021.

(51) Int. Cl. H04B 7/06

(52) U.S. Cl. CPC H04B 7/0626; H04B 7/06968

(57) ABSTRACT

A method, system and apparatus are disclosed. A network node configured to communicate with a wireless device (WD) is described. The network node includes processing circuitry configured to: determine a plurality of channel state information reference signal (CSI-RS) configurations. The determined plurality of CSI-RS configurations includes at least a first CSI-RS configuration and a second CSI-RS configuration. The first and second CSI-RS configurations include different values for at least one parameter. One of the first CSI-RS configuration and the second CSI-RS configuration is determined. A radio interface is configured to transmit, to the WD, an indication indicating the determined one of the first CSI-RS configuration and the second CSI-RS configuration, the indication being transmitted using at least one of physical communication layer signaling and media access control (MAC) layer signaling.

### TECHNICAL FIELD

The present disclosure relates to wireless communications, and in particular, to channel state information-reference signal (CSI-RS) enhancements for wireless devices.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

### NW Energy Consumption

The network (NW) power consumption for NR is said to be less, as compared to LTE because of its lean design. In the current implementation, however, NR may consume more power compared to LTE, e.g., due to the higher bandwidth and more so due to introduction of additional elements such as 64 transmit/receive (TX/RX) ports with several digital radio frequency (RF) chains. As the NW such as via network node (e.g., base station) is expected to be able to support the WD with its maximum capability (e.g., throughput, coverage, etc.), the network node (e.g.,, NW) may need to use full configuration even when the maximum NW support is actually rarely needed by the WDs.

In addition, an increased number of TX/RX ports also leads to an increase in the number of reference signals (e.g., CSI-RS) needed to be transmitted by the network node (e.g., NW) (and to be measured by the WD) for a proper signal detection, e.g., signal detection meeting a predefined criterion. Thus, the additional TX/RX ports may result in another additional power consumption, i.e., to transmit a larger number of CSI-RS to the WDs. Furthermore, it should also be noted that the larger number of CSI-RS transmissions may also consume the valuable NW resources.

### CSI-RS Configuration

In NR, the CSI-RS generation procedures are defined in 3GPP Technical Specification (TS) 38.211 Section 7.4.1.5. The CSI-RS may be used for time/frequency tracking, CSI computation, Layer 1 reference signal received power (L1-RSRP) computation, Layer 1 signal-to-noise ratio (L1-SINR) computation and mobility. Configured with CSI-RS, the WD may then follow the procedures described in 3GPP TS 38.214 Section 5.1.6.1.

For a CSI-RS resource associated with an NZP-CSI-RS-ResourceSet with the higher layer parameter repetition set to ‘on’, the WD may not expect to be configured with CSI-RS over the symbols during which the WD is also configured to monitor the control resource set (CORESET). For other NZP-CSI-RS-ResourceSet configurations, if the WD is configured with a CSI-RS resource and a search space set associated with a CORESET in the same orthogonal frequency division multiplexing (OFDM) symbol(s), the WD may assume that the CSI-RS and a physical downlink control channel (PDCCH) demodulation reference signal (DM-RS or DMRS) transmitted in all the search space sets associated with CORESET are quasi co-located with ‘typeD’, if ‘typeD’ is applicable. This may also apply to the case when CSI-RS and the CORESET are in different intra-band component carriers, if ‘typeD’ is applicable. Furthermore, the WD may not expect to be configured with the CSI-RS in physical resource blocks (PRBs) that overlap those of the CORESET in the OFDM symbols occupied by the search space set(s).

In addition, the WD may not be expected to receive CSI-RS and system information block 1 (SIB1) message in the overlapping PRBs in the OFDM symbols where SIB1 is transmitted. If the WD is configured with discontinuous reception (DRX) and/or:
if the WD is configured to monitor downlink control information (DCI) format 2_6 and configured by higher layer parameter ps-TransmitOtherPeriodicCSI to report CSI (e.g., with the higher layer parameters reportConfigType set to ‘periodic’ and reportQuantity set to quantities other than ‘cri-RSRP’ and ‘ssb-Index-RSRP’) when drx-onDurationTimer in DRX-Config is not started, the most recent CSI measurement occasion may occur in DRX active time or during the time duration indicated by drx-onDurationTimer in DRX-Config. also outside DRX active time for CSI to be reported;
if the WD is configured to monitor DCI format 2_6 and configured by higher layer parameter ps-TransmitPeriodicL1-RSRP to report L1-RSRP (e.g., with the higher layer parameter reportConfigType set to ‘periodic’ and reportQuantity set to cri-RSRP) when drx-onDurationTimer in DRX-Config is not started, the most recent CSI measurement occasion may occur in DRX active time or during the time duration indicated by drx-onDurationTimer in DRX-Config, also outside DRX active time for CSI to be reported;
otherwise, the most recent CSI measurement occasion may occur in DRX active time for CSI to be reported.

According to the specification of NR, e.g., 3GPP TS 38.214 Section 5.2.2.3.1, a WD can be configured with one or more non-zero power (NZP) CSI-RS resource set configuration(s) as indicated by the higher layer parameters CSI-ResourceConfig, and NZP-CSI-RS-ResourceSet. Each NZP CSI-RS resource set includes K≥1 NZP CSI-RS resource(s). The following is an example configuration, e.g., from 3GPP TS 38.331 regarding CSI-ResourceConfig:

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

```
  ...
}
-- TAG-CSI-RESOURCECONFIG-STOP
-- ASN1STOP
      Below is an example NZP-CSI-RS-ResourceSet:
-- ASN1START
-- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId

| | |
|---|---|
| repetition | ENUMERATED { on, off } |

| | |
|---|---|
| OPTIONAL, | -- Need S |

| | |
|---|---|
| aperiodicTriggeringOffset | INTEGER(0..6) |

| | |
|---|---|
| OPTIONAL, | -- Need S |

| | |
|---|---|
| trs-Info | ENUMERATED {true} |

| | |
|---|---|
| OPTIONAL, | -- Need R |

```
  ...,
  [[
```

| | |
|---|---|
| aperiodicTriggeringOffset-r16 | INTEGER(0..31) |

| | |
|---|---|
| OPTIONAL | -- Need S |

]]
}
-- TAG-NZP-CSI-RS-RESOURCESET-STOP
-- ASN1STOP

In each NZP CSI-RS resourcesm the network node (e.g., NW) can set the CSI-RS resource with different powerControlOffset, scramblingID, etc. The following is captured from 3GPP TS 38.331:

| -- ASN1START | |
|---|---|
| -- TAG-NZP-CSI-RS-RESOURCE-START | |
| NZP-CSI-RS-Resource ::= | SEQUENCE { |
| nzp-CSI-RS-ResourceId | , |
| resourceMapping | CSI-RS-ResourceMapping, |
| powerControlOffset | INTEGER (−8..15), |
| powerControlOffsetSS | ENUMERATED {db-3, db0, db3, db6} |

| | |
|---|---|
| OPTIONAL, | -- Need R |

| | |
|---|---|
| scramblingID | ScramblingId, |
| periodicity AndOffset | CSI-ResourcePeriodicity AndOffset |

| | |
|---|---|
| OPTIONAL, | -- Cond PeriodicOrSemiPersistent |

| | |
|---|---|
| qcl-InfoPeriodicCSI-RS | TCI-StateId |

| | |
|---|---|
| OPTIONAL, | -- Cond Periodic |

...
}
-- TAG-NZP-CSI-RS-RESOURCE-STOP
-- ASN1STOP

Before transmitted, the CSI-RS may be mapped according to the configured CSI-RS-ResourceMapping. The network node (e.g., NW) may set the configuration of the cdm-Type, frequency DomainAllocation, nrofPorts, etc. The following is an example resource mapping configuration.

-- ASN1START
-- TAG-CSI-RS-RESOURCEMAPPING-START

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD2, |

cdm8-FD2-TD4},

| | |
|---|---|
| density | CHOICE { |
| dot5 | ENUMERATED {evenPRBs, oddPRBs}, |
| one | NULL, |
| three | NULL, |
| spare | NULL |

},

| | |
|---|---|
| freqBand | CSI-Frequency Occupation, |

...
}
-- TAG-CSI-RS-RESOURCEMAPPING-STOP
-- ASN1STOP

An example explanation of CSI-RS parameters can be found in 3GPP TS. 38.214 section 5.2.2.3.1, e.g.:
nzp-CSI-RS-ResourceId determines CSI-RS resource configuration identity.
periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.
resourceMapping defines the number of ports, code division multiplexing type (CDM-type), and OFDM symbol and subcarrier occupancy of the CSI-RS resource within a slot that are given in Clause 7.4.1.5 of 3GPP TS 38.211.
nrofPorts in resourceMapping defines the number of CSI-RS ports, where the allowable values are given in Clause 7.4.1.5 of 3GPP TS 38.211.
density in resourceMapping defines CSI-RS frequency density of each CSI-RS port per PRB, and CSI-RS PRB offset in case of the density value of ½, where the allowable values are given in Clause 7.4.1.5 of 3GPP TS 38.211. For density ½, the odd/even PRB allocation indicated in density is with respect to the common resource block grid.
cdm-Type in resourceMapping defines CDM values and pattern, where the allowable values are given in Clause 7.4.1.5 of 3GPP TS 38.211.
powerControlOffset: which is the assumed ratio of physical downlink shared channel (PDSCH) power for one resource element (EPRE) to NZP CSI-RS EPRE when WD derives CSI feedback and takes values in the range of [−8, 15] dB with 1 dB step size.
powerControlOffsetSS: which is the assumed ratio of NZP CSI-RS EPRE to synchronization signal/physical broadcast channel (SS/PBCH) block EPRE.
scramblingID defines scrambling identifier (ID) of CSI-RS with length of 10 bits.
BWP-Id in CSI-ResourceConfig defines which bandwidth part (BWP) the configured CSI-RS is located in.
qcl-InfoPeriodicCSI-RS contains a reference to a TCI-State indicating quasi-colocated (QCL) source reference signal(s) (RS(s)) and QCL type(s). If the TCI-State is configured with a reference to an RS configured with qcl-Type set to ‘typeD’ association, that RS may be an SS/PBCH block located in the same or different component carrier/downlink (CC/DL) BWP or a CSI-RS resource configured as periodic located in the same or different CC/DL BWP.

The CSI-RS resource (or the CSI-RS resource-set) that the WD may use to measure may be configured in radio resource control (RRC) configuration, e.g., in the CSI-MeasConfig information element (IE). In the IE, the network node (e.g., NW), e.g., based on a consideration, may add, or remove (release) the CSI-RS or the (CSI-RS resource-set) that WD uses to measure. The following is an example measurement configuration, e.g., as described in 3GPP TS 38.331.

-- ASN1START
-- TAG-CSI-MEASCONFIG-START

| | |
|---|---|
| CSI-MeasConfig ::= | SEQUENCE { |

```
  nzp-CSI-RS-ResourceToAddModList  SEQUENCE (SIZE (1..maxNrofNZP-CSI-
RS-Resources)) OF NZP-CSI-RS-Resource
OPTIONAL, -- Need N
  nzp-CSI-RS-ResourceToReleaseList  SEQUENCE (SIZE (1..maxNrofNZP-CSI-
RS-Resources)) OF NZP-CSI-RS-ResourceId
OPTIONAL, -- Need N
  nzp-CSI-RS-ResourceSetToAddModList SEQUENCE (SIZE (1..maxNrofNZP-
CSI-RS-ResourceSets)) OF NZP-CSI-RS-ResourceSet
OPTIONAL, -- Need N
  nzp-CSI-RS-ResourceSetToReleaseList SEQUENCE (SIZE (1..maxNrofNZP-CSI-
RS-ResourceSets)) OF NZP-CSI-RS-ResourceSetId
```

| | |
|---|---|
| csi-IM-ResourceToAddModList | SEQUENCE (SIZE (1..maxNrofCSI-IM- |

Resources)) OF CSI-IM-Resource
OPTIONAL, -- Need N

| | |
|---|---|
| csi-IM-ResourceToReleaseList | SEQUENCE (SIZE (1..maxNrofCSI-IM- |

```
Resources)) OF CSI-IM-ResourceId
OPTIONAL, -- Need N
  csi-IM-ResourceSetToAddModList  SEQUENCE (SIZE (1..maxNrofCSI-IM-
ResourceSets)) OF CSI-IM-ResourceSet
OPTIONAL, -- Need N
  csi-IM-ResourceSetToReleaseList  SEQUENCE (SIZE (1..maxNrofCSI-IM-
ResourceSets)) OF CSI-IM-ResourceSetId
OPTIONAL, -- Need N
  csi-SSB-ResourceSetToAddModList  SEQUENCE (SIZE (1..maxNrofCSI-SSB-
ResourceSets)) OF CSI-SSB-ResourceSet
OPTIONAL, -- Need N
  csi-SSB-ResourceSetToReleaseList  SEQUENCE (SIZE (1..maxNrofCSI-SSB-
ResourceSets)) OF CSI-SSB-ResourceSetId OPTIONAL, -- Need N
  csi-ResourceConfigToAddModList  SEQUENCE (SIZE (1..maxNrofCSI-
ResourceConfigurations)) OF CSI-ResourceConfig
OPTIONAL, -- Need N
  csi-ResourceConfigToReleaseList  SEQUENCE (SIZE (1..maxNrofCSI-
ResourceConfigurations)) OF CSI-ResourceConfigId
OPTIONAL, -- Need N
```

| | |
|---|---|
| csi-ReportConfigToAddModList | SEQUENCE (SIZE (1..maxNrofCSI- |

ReportConfigurations)) OF CSI-ReportConfig OPTIONAL, -- Need N

| | |
|---|---|
| csi-ReportConfigToReleaseList | SEQUENCE (SIZE (1..maxNrofCSI- |

ReportConfigurations)) OF CSI-ReportConfigId
OPTIONAL, -- Need N

| | |
|---|---|
| reportTriggerSize | INTEGER (0..6) |

OPTIONAL, -- Need M

| | |
|---|---|
| aperiodicTriggerStateList | SetupRelease { CSI-AperiodicTriggerStateList } |

```
OPTIONAL, -- Need M
  semiPersistentOnPUSCH-TriggerStateList  SetupRelease { CSI-
SemiPersistentOnPUSCH-TriggerStateList }
OPTIONAL, -- Need M
  ...,
  [[
```

| | |
|---|---|
| reportTriggerSizeDCI-0-2-r16 | INTEGER (0..6) |

OPTIONAL -- Need R
]]
}
-- TAG-CSI-MEASCONFIG-STOP
-- ASN1STOP

After receiving the CSI-RS, the WD may report its measurement back to the network node (e.g., NW). The reporting configuration for CSI can be aperiodic (using physical uplink shared channel (PUSCH)), periodic (using physical uplink control channel (PUCCH)) or semi-persistent (using PUCCH, and DCI activated PUSCH). The CSI-RS Resources can be periodic, semi-persistent, or aperiodic. One or more supported combinations of configurations may be used, e.g., Table 5.2.1.4-1 in 3GPP TS 38.214 (reproduced below) shows example supported combinations of CSI Reporting configurations and CSI-RS Resource configurations, and how the CSI Reporting may be triggered for each CSI-RS Resource configuration.

TABLE 1
Triggering/Activation of CSI Reporting
for the possible CSI-RS Configurations.

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the WD | additionally, |
| | activation | receives an | subselection |
| | | activation | indication as |
| | | command, as | described in |
| | | described in clause | clause 6.1.3.13 of |
| | | 6.1.3.16 of [3GPP | [3GPP TS 38.321] |
| | | TS 38.321]; for | possible as |
| | | reporting on | defined in Clause |
| | | PUSCH, the WD | 5.2.1.5.1. |
| | | receives triggering | |
| | | on DCI | |
| Semi- | Not | For reporting on | Triggered by DCI; |
| Persistent | Supported | PUCCH, the WD | additionally, |
| CSI-RS | | receives an | subselection |
| | | activation | indication as |
| | | command, as | described in |
| | | described in clause | clause 6.1.3.13 of |
| | | 6.1.3.16 of [3GPP | [3GPP TS 38.321] |
| | | TS 38.321]; for | possible as |
| | | reporting on | defined in Clause |
| | | PUSCH, the WD | 5.2.1.5.1. |
| | | receives triggering | |
| | | on DCI | |
| Aperiodic | Not | Not Supported | Triggered by DCI; |
| CSI-RS | Supported | | additionally, |
| | | | subselection |
| | | | indication as |
| | | | described in |
| | | | clause 6.1.3.13 of |
| | | | [3GPP TS 38.321] |
| | | | possible as |
| | | | defined in Clause |
| | | | 5.2.1.5.1. |

In sum, existing processes associated with CSI (e.g., CSI-RS) are inefficient as the network node (and/or WDs) cannot adapt to predetermined changes, i.e., the network node (and/or WDs) cannot adapt port configurations without hindering port adaptation, causing excessive RRC signaling, and affecting WD performance.

### SUMMARY

Some embodiments advantageously provide methods, systems, and apparatuses for CSI-RS enhancements for NR WD (e.g., NR UE).

In one embodiment, a network node is configured to cause the network node to transmit multiple channel state information-reference signal (CSI-RS) configurations to the WD: determine to use a first CSI-RS configuration of the multiple CSI-RS configurations for the WD; and indicate the first CSI-RS configuration to the WD (e.g., UE) via at least one of a downlink control information (DCI) and a medium access control (MAC) control element (CE).

In one embodiment, a wireless device (e.g., user equipment (UE)) is configured to cause the WD to receive multiple channel state information-reference signal (CSI-RS) configurations: receive an indication of a first CSI-RS configuration of the multiple CSI-RS configurations via at least one of a downlink control information (DCI) and a medium access control (MAC) control element (CE); and as a result of the indication, perform a CSI-RS procedure using the first CSI-RS configuration.

According to one aspect, a network node configured to communicate with a wireless device (WD) is described. The network node includes processing circuitry configured to determine a plurality of channel state information reference signal (CSI-RS) configurations. The determined plurality of CSI-RS configurations includes at least a first CSI-RS configuration and a second CSI-RS configuration, which include different values for at least one parameter. The processing circuitry is further configured to determine one of the first CSI-RS configuration and the second CSI-RS configuration that is usable by the WD to perform a CSI procedure. The one of the first CSI-RS configuration and the second CSI-RS configuration are determined based on at least one condition. A radio interface in communication with the processing circuitry is configured to transmit, to the WD, an indication indicating the determined one of the first CSI-RS configuration and the second CSI-RS configuration. The indication being transmitted using at least one of physical communication layer signaling and media access control (MAC) layer signaling.

In some embodiments, the at least one parameter is associated with a CSI-RS resource, where each one of the first and second CSI-RS configurations has at least one CSI-RS resource value that is different.

In some other embodiments, the at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated, QCL, information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the transmitted indication triggers the WD to at least one of: activate one of the first CSI-RS configuration and the second CSI-RS configuration to perform the CSI procedure: deactivate one of the first CSI-RS configuration and the second CSI-RS configuration to perform the CSI procedure; switch from the first CSI-RS configuration to the second CSI-RS configuration to perform the CSI procedure; and switch from the second CSI-RS configuration to the first CSI-RS configuration to perform the CSI procedure.

In an embodiment, the radio interface is further configured to: transmit a CSI-RS based on the determined one of the first CSI-RS configuration and the second CSI-RS configuration; and receive a CSI report as part of the CSI procedure. The CSI report includes at least one measurement based on the determined one of the first CSI-RS configuration and the second CSI-RS configuration.

In another embodiment, the at least one condition is associated with a port quantity, a beam shape, a quantity of WDs supported by the network node, a power adaptation, a QCL parameter value, and an energy consumption by the network node.

In some embodiments, the at least one of the physical communication layer signaling and the MAC layer signaling includes at least one of downlink control information (DCI) and a MAC control element (CE); and/or the radio interface is further configured to transmit, via radio resource control signaling, at least the first and second CSI-RS configurations of the plurality of CSI-RS configurations to the WD for the WD to select one of the first and second CSI-RS configurations based at least in part on the transmitted indication.

According to another aspect, a method in a network node configured to communicate with a wireless device (WD) is described. The method includes determining a plurality of channel state information reference signal (CSI-RS) configurations. The determined plurality of CSI-RS configurations includes at least a first CSI-RS configuration and a second CSI-RS configuration. The first and second CSI-RS configurations comprise different values for at least one parameter. The method further includes determining one of the first CSI-RS configuration and the second CSI-RS configuration that is usable by the WD to perform a CSI procedure. The one of the first CSI-RS configuration and the second CSI-RS configuration is determined based on at least one condition. Further, the method includes transmitting, to the WD, an indication indicating the determined one of the first CSI-RS configuration and the second CSI-RS configuration. The indication is transmitted using at least one of physical communication layer signaling and media access control, MAC, layer signaling.

In some embodiments, the at least one parameter is associated with a CSI-RS resource, where each one of the first and second CSI-RS configurations has at least one CSI-RS resource value that is different.

In some other embodiments, the at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated, QCL, information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the transmitted indication triggers the WD to at least one of: activate one of the first CSI-RS configuration and the second CSI-RS configuration to perform the CSI procedure: deactivate one of the first CSI-RS configuration and the second CSI-RS configuration to perform the CSI procedure; switch from the first CSI-RS configuration to the second CSI-RS configuration to perform the CSI procedure; and switch from the second CSI-RS configuration to the first CSI-RS configuration to perform the CSI procedure.

In an embodiment, the method further includes: transmitting a CSI-RS based on the determined one of the first CSI-RS configuration and the second CSI-RS configuration; and receiving a CSI report as part of the CSI procedure. The CSI report includes at least one measurement based on the determined one of the first CSI-RS configuration and the second CSI-RS configuration.

In another embodiment, the at least one condition is associated with a port quantity, a beam shape, a quantity of WDs supported by the network node, a power adaptation, a QCL parameter value, and an energy consumption by the network node.

In some embodiments, the at least one of the physical communication layer signaling and the MAC layer signaling includes at least one of downlink control information (DCI) and a MAC control element (CE); and/or the method further includes transmitting, via radio resource control signaling, at least the first and second CSI-RS configurations of the plurality of CSI-RS configurations to the WD for the WD to select one of the first and second CSI-RS configurations based at least in part on the transmitted indication.

According to one aspect, a wireless device (WD) configured to communicate with a network node is described. The WD includes a radio interface configured to receive an indication indicating one of a first channel state information reference signal (CSI-RS) configuration and a second CSI-RS configuration of a plurality of CSI-RS configurations. The first and second CSI-RS configurations are based on at least one condition and usable by the WD to perform a CSI procedure. The first and second CSI-RS configurations include different values for at least one parameter. The indication is transmitted using at least one of physical communication layer signaling and media access control (MAC) layer signaling. The WD further includes processing circuitry in communication with the radio interface and configured to perform the CSI procedure based on one of the first CSI-RS configuration and the second CSI-RS configuration.

In some embodiments, the at least one parameter is associated with a CSI-RS resource, each one of the first and second CSI-RS configurations having at least one CSI-RS resource value that is different.

In some other embodiments, at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated (QCL) information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the processing circuitry is further configured to, based on the received indication: activate one of the first CSI-RS configuration and the second CSI-RS configuration to perform the CSI procedure: deactivate one of the first CSI-RS configuration and the second CSI-RS configuration to perform the CSI procedure: switch from the first CSI-RS configuration to the second CSI-RS configuration to perform the CSI procedure; and switch from the second CSI-RS configuration to the first CSI-RS configuration to perform the CSI procedure.

In an embodiment, the radio interface is further configured to receive a CSI-RS based on the one of the first CSI-RS configuration and the second CSI-RS configuration; and transmit a CSI report as part of the CSI procedure, where the CSI report includes at least one measurement based on the one of the first CSI-RS configuration and the second CSI-RS configuration. The processing circuitry is further configured to perform the at least one measurement and determine the CSI report.

In another embodiment, the at least one condition is associated with a port quantity, a beam shape, a quantity of WDs supported by the network node, a power adaptation, a QCL parameter value, and an energy consumption by the network node.

In some embodiments, the at least one of the physical communication layer signaling and the MAC layer signaling includes at least one of downlink control information (DCI) and a MAC control element, CE; and/or the radio interface is further configured to receive, via radio resource control signaling, at least the first and second CSI-RS configurations of the plurality of CSI-RS configurations to the WD; and/or the processing circuitry is further configured to select one of the received first and second CSI-RS configurations based at least in part on the received indication to perform the CSI procedure.

According to another aspect, a method in a wireless device (WD) configured to communicate with a network node is described. The method includes receiving an indication indicating one of a first channel state information reference signal (CSI-RS) configuration and a second CSI-RS configuration of a plurality of CSI-RS configurations. The first and second CSI-RS configurations are based on at least one condition and usable by the WD to perform a CSI procedure. The first and second CSI-RS configurations include different values for at least one parameter. The indication is transmitted using at least one of physical communication layer signaling and media access control (MAC) layer signaling. The CSI procedure is performed based on one of the first CSI-RS configuration and the second CSI-RS configuration.

In some embodiments, the at least one parameter is associated with a CSI-RS resource, where each one of the first and second CSI-RS configurations has at least one CSI-RS resource value that is different.

In some other embodiments, the at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated (QCL) information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the method further includes, based on the received indication: activating one of the first CSI-RS configuration and the second CSI-RS configuration to perform the CSI procedure: deactivating one of the first CSI-RS configuration and the second CSI-RS configuration to perform the CSI procedure; switching from the first CSI-RS configuration to the second CSI-RS configuration to perform the CSI procedure; and switching from the second CSI-RS configuration to the first CSI-RS configuration to perform the CSI procedure.

In an embodiment, the method further includes receiving a CSI-RS based on the one of the first CSI-RS configuration and the second CSI-RS configuration: performing at least one measurement based on one of the first CSI-RS configuration and the second CSI-RS configuration: determining CSI report as part of the CSI procedure, the CSI report including the at least one measurement; and transmitting the CSI report.

In another embodiment, the at least one condition is associated with a port quantity, a beam shape, a quantity of WDs supported by the network node, a power adaptation, a QCL parameter value, and an energy consumption by the network node.

In some embodiments, the at least one of the physical communication layer signaling and the MAC layer signaling includes at least one of downlink control information (DCI) and a MAC control element (CE); and/or the method further includes receiving, via radio resource control signaling, at least the first and second CSI-RS configurations of the plurality of CSI-RS configurations to the WD; and/or selecting one of the received first and second CSI-RS configurations based at least in part on the received indication to perform the CSI procedure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure:

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure:

FIG. 5 is a flowchart illustrating example methods implemented in a communication system including a host computer, a network node and a wireless device for receiving user data from the wireless device at a host computer according to some embodiments of the present disclosure:

FIG. 6 is a flowchart illustrating example methods implemented in a communication system including a host computer, a network node and a wireless device for receiving user data at a host computer according to some embodiments of the present disclosure:

FIG. 7 is a flowchart of an example process in a network node according to some embodiments of the present disclosure:

FIG. 8 is a flowchart of an example process in a wireless device according to some embodiments of the present disclosure:

FIG. 9 is a flowchart of another example process in a network node according to some embodiments of the present disclosure; and

FIG. 10 is a flowchart of another example process in a wireless device according to some embodiments of the present disclosure.

### DETAILED DESCRIPTION

As described above, when considering that the network node (e.g., NW) may consume high power when a large quantity of antennas are active (e.g., a quantity of antennas that exceeds a predetermined threshold), it is useful for the TX/RX ports to be used efficiently. For example, the network node (e.g., NW) may use a large quantity of antennas when its full transmission capability is requested, e.g., when the quantity of WDs in the cell and/or when many WDs are in a high-throughput type of services. When the quantity of the WDs currently active in the cell is small (quantity does not exceed a predetermined threshold) and/or the WDs are close (e.g., relatively close, within a predetermined distance) to the network node (e.g., base station), a predetermined quantity of TX/RX ports (e.g., a small quantity of ports) may be used by the network node (e.g., NW), e.g., instead of letting all of the TX/RX ports active.

A different quantity of ports, however, may result in a different beam-shape of transmitted signals. Therefore, it may be useful for the WD to align with the network node (e.g., NW) on which CSI-RS resource is to be measured by the WD to make sure that the WD does not encounter beam failure.

Changes in utilized ports and resulting beam shapes may also affect CSI-RS transmissions and measurements by the WD. The WD configuration is to be as dynamic as the use of port adaptation. In existing systems, the change on the periodic CSI-RS configuration can be performed through radio resource control (RRC) reconfiguration. This, however, requires a relatively long time before the adaptation can actually be applied since RRC signaling may be slower than other types of signaling. In other words, a faster dynamic adaptation on the CSI-RS resource configuration may be useful.

When the network node (e.g., NW) uses aperiodic CSI-RS configuration or reporting, the network node (e.g., NW) can indicate to the WD on which CSI-RS resources the measurement should be performed. For example, multiple different CSI-RS resources may be configured with different beam configurations, and the WD directed towards different configurations at different time instances. However, there may be a limited quantity of possible CSI-RS resources or CSI-RS resource set that can be configured for a WD, i.e., the CSI-RS resources are limited to 192, while CSI-RS resource set are limited to 64, and thus when the network node (e.g., NW, gNB) may uses a large quantity of ports.

Some embodiments of the present disclosure provide for methods (e.g., and mechanisms), devices, systems for a faster and more resource-efficient dynamic CSI-RS configuration adaptation, e.g., by using one or more of the following alternatives:
Configuring multiple resource mappings, or multiple configurations per parameter within a CSI-RS resource, e.g., different quantity/number of ports, power control offset, QCL info, etc., and using medium access control (MAC) control element (CE) or DCI to activate/deactivate a certain configuration (or switch between those configurations).
Configuring multiple CSI-RS resources within one CSI-RS resource set and using MAC CE or DCI to activate/deactivate the configured CSI-RS resources (or switching between CSI-RS resources).
Configuring multiple CSI-RS resource sets and/or using MAC CE or DCI to activate/deactivate one or more configured CSI-RS resource set (or switching between CSI-RS resource sets).

In some embodiments, the total quantity of configured CSI-RS resources and CSI-RS resource sets may be allowed to be higher than predetermined thresholds, e.g., 192 and 64 per cell, respectively.

Some embodiments may include one or more of the following:

A method implemented in the network node (e.g., NW) may include one or more of the following steps:
1—Configuring the WD with multiple CSI-RS configurations,
   where the multiple configurations may be achieved through one or more of:
      setting multiple configurations for a parameter in the CSI-RS resource.
      setting multiple CSI-RS resources where each of the CSI-RS resource differs in at least one parameter.
      Setting multiple CSI-RS resource sets where each of the CSI resource set differs in at least one CSI-RS resource parameter.
   where one configuration is a default configuration.
2—Transmitting an indication to the WD to change from a first CSI-RS configuration to a second CSI-RS configuration, using either of
   where the indication is transmitted using MAC-CE.
   where the indication is transmitted using DCI.
3—Transmitting an indication to a group of one or more WDs to change from a first CSI-RS configuration to a second CSI-RS configuration, using either of
   where the indication is transmitted using group MAC-CE.
   where the indication is transmitted using DCI with group common search space.
   where the indication to a group of WDs is to switch to a CSI-RS configuration specified by physical properties of the configuration (e.g., with most time/frequency/port resources)

On the WD side, the WD may be configured to perform one or more procedures related to the multiple CSI-RS configurations accordingly, e.g.:
Receiving multiple CSI-RS configurations from the network node (e.g., NW).
Receiving an indication which of the multiple configuration is active.
Performing CSI-RS related procedures using the active CSI-RS configuration.

Some embodiments may advantageously provide arrangements in which the WD may not require a full RRC reconfiguration to dynamically change the CSI-RS configuration, e.g., when the network node changes the quantity of TX/RX ports. A faster adaptation, therefore, may be obtained while also saving NW signaling and energy resources, and WD power.

Before describing in detail example embodiments, it is noted that the embodiments reside primarily in combinations of apparatus components and processing steps related to arrangements for CSI-RS enhancements for WDs, e.g., NR WDs. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second.” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises.” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled.” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a UE or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrow band IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “radio measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Generally, it may be considered that the network, e.g., a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in quantity of bits it may carry, e.g., information or payload bits, or total quantity of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages (e.g., DCI indication). It may be considered that receiving control signaling comprises demodulating and/or decoding and/or detecting, e.g., blind detection of, one or more messages, in particular a message carried by the control signaling, e.g., based on an assumed set of resources, which may be searched and/or listened for the control information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of the first CSI-RS configuration, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Transmitting in downlink may pertain to transmission from the network or network node to a terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to perform certain measurements on certain subframes or radio resources and reporting such measurements according to embodiments of the present disclosure.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node: a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

In some embodiments, the term number of ports may refer to quantity of ports and/or refer to a parameter such as nrofPorts.

Predefined in the context of this disclosure may refer to the related information being defined for example in a standard, and/or being available without specific configuration from a network or network node, e.g., stored in memory, for example independent of being configured. Configured or configurable may be considered to pertain to the corresponding information being set/configured, e.g., by the network or a network node.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for CSI-RS enhancements for NR WD.

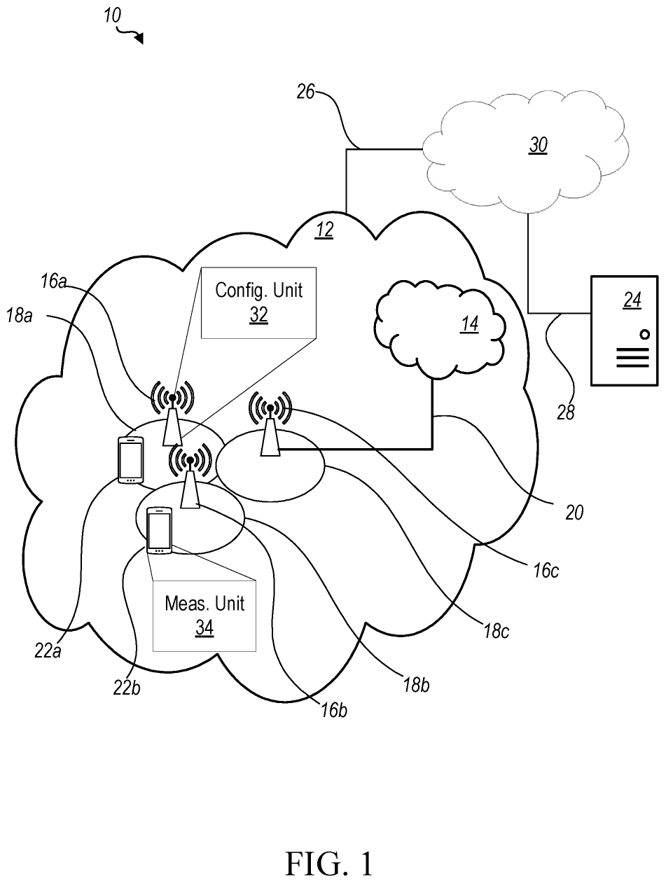

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first WD 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration (config.) unit 32 which is configured to perform any step and/or task and/or process and/or method and/or feature described in the present disclosure, e.g., transmit multiple channel state information-reference signal (CSI-RS) configurations to the WD; and/or determine to use a first CSI-RS configuration of the multiple CSI-RS configurations for the WD; and/or indicate the first CSI-RS configuration to the WD via at least one of a downlink control information (DCI) and a medium access control (MAC) control element (CE).

A wireless device 22 is configured to include a measurement (meas.) unit 34 which is configured to receive multiple channel state information-reference signal (CSI-RS) configurations: receive an indication of a first CSI-RS configuration of the multiple CSI-RS configurations via at least one of a downlink control information (DCI) and a medium access control (MAC) control element (CE); and as a result of the indication, perform a CSI-RS procedure using the first CSI-RS configuration.

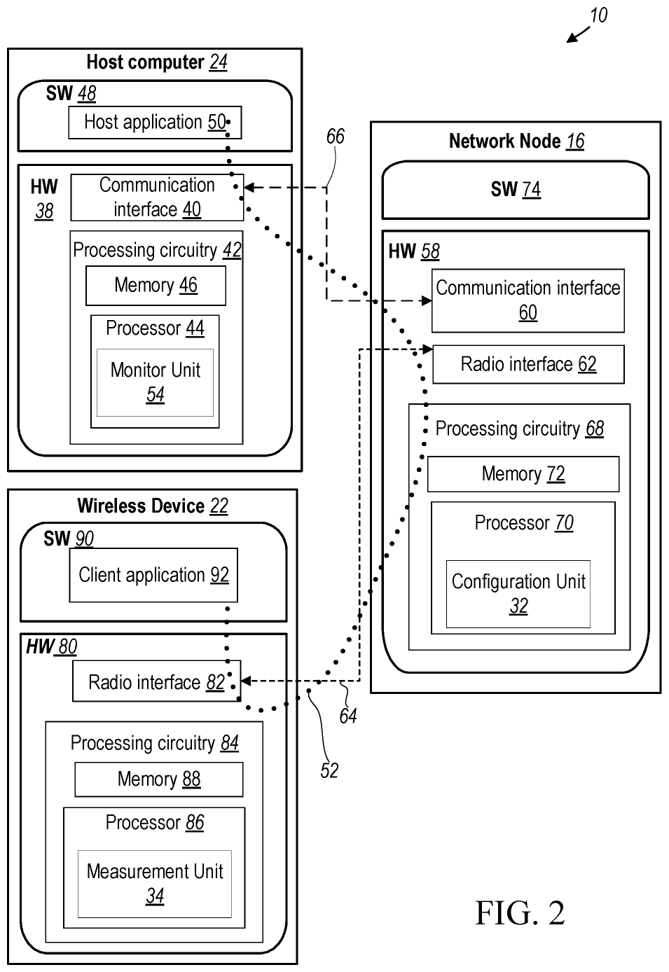

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit. and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

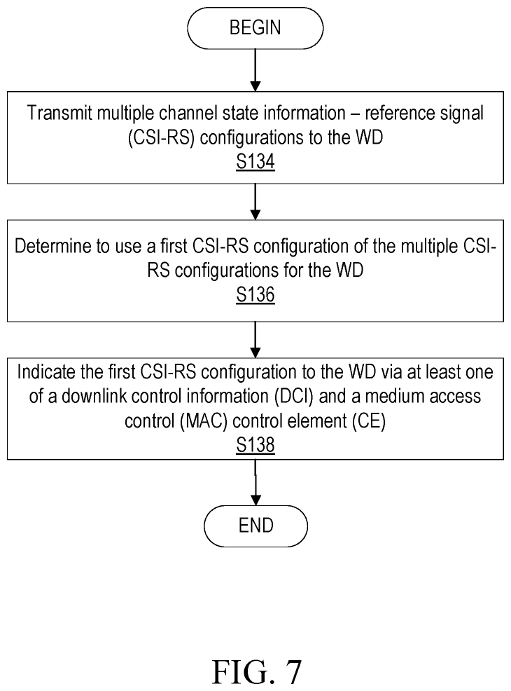

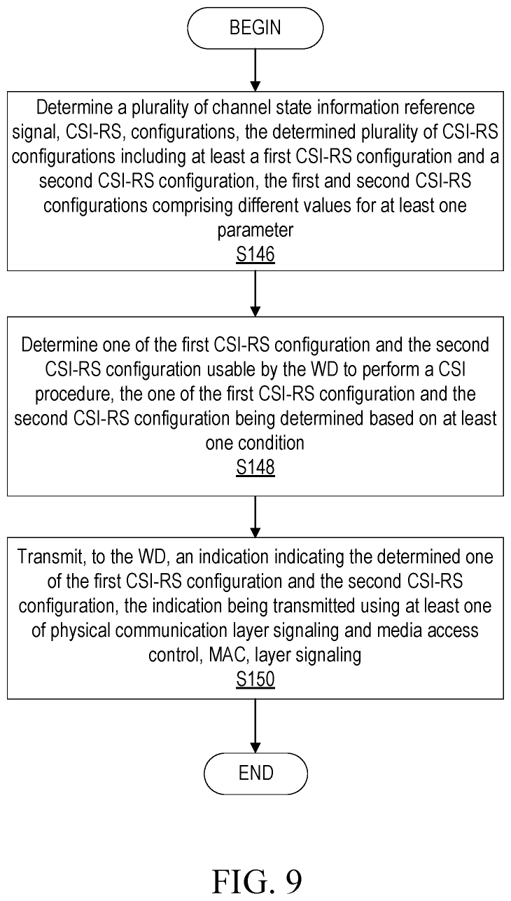

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform any step and/or task and/or process and/or method and/or feature described in the present disclosure, e.g., perform network node methods discussed herein, such as the methods discussed with reference to FIGS. 7 and 9 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

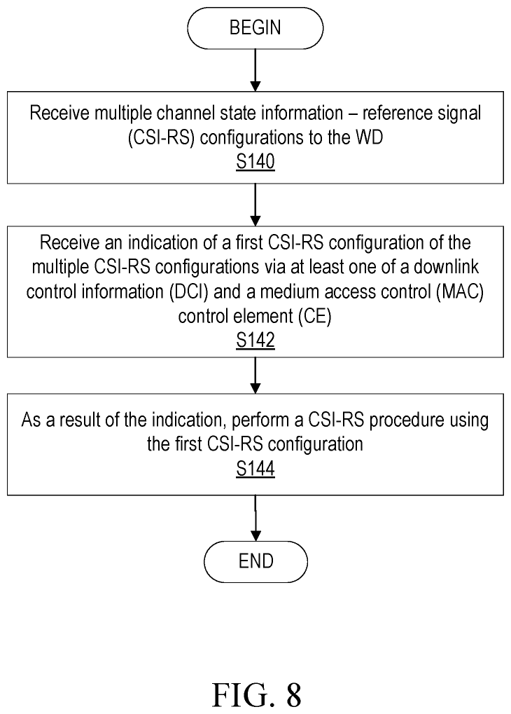

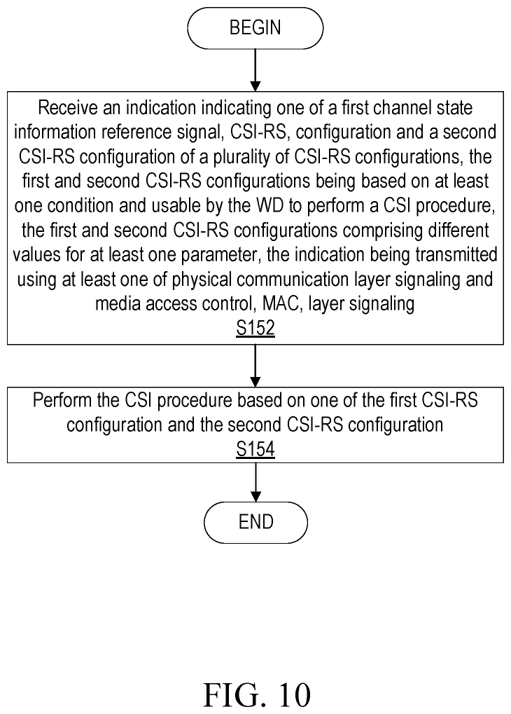

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform any step and/or task and/or process and/or method and/or feature described in the present disclosure, e.g., perform WD, methods discussed with reference to FIGS. 8 and 10 as well as other figures.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.: the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

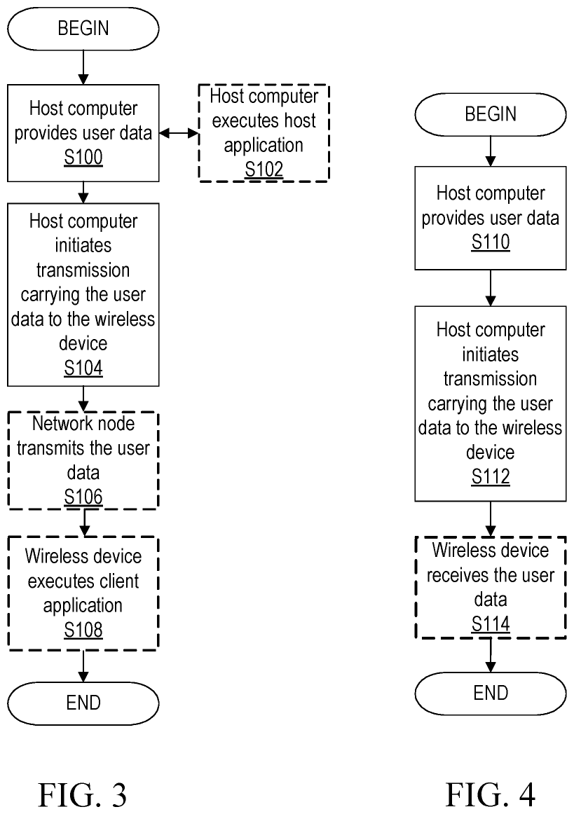

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

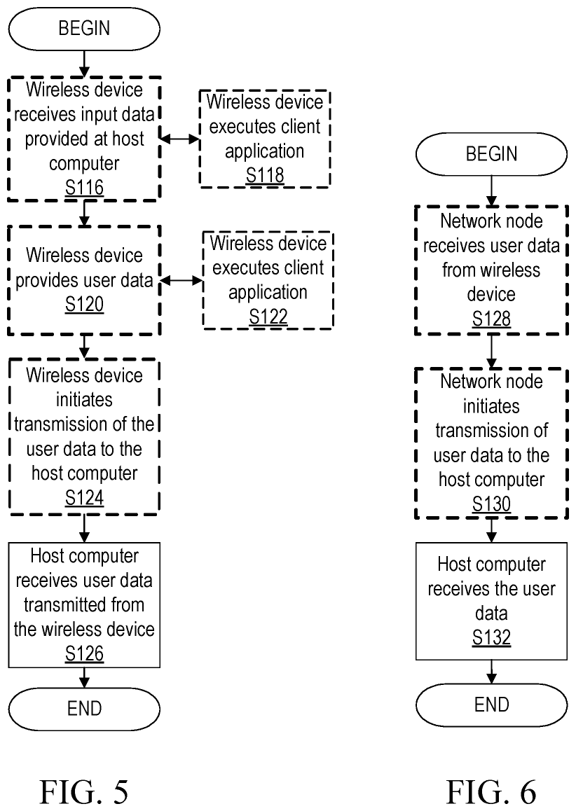

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 7 is a flowchart of an example process in a network node 16 according to some embodiments of the present disclosure. One or more Blocks and/or functions and/or methods performed by the network node 16 may be performed by one or more elements of network node 16 such as by configuration unit 32 in processing circuitry 68, processor 70, and/or radio interface 62, etc. according to the example method. Network node 16 is configured to transmit (Block S134) multiple channel state information-reference signal (CSI-RS) configurations to the WD. Network node 16 is configured to determine (Block S136) to use a first CSI-RS configuration of the multiple CSI-RS configurations for the WD. Network node 16 is configured to indicate (Block S138) the first CSI-RS configuration to the WD via at least one of a downlink control information (DCI) and a medium access control (MAC) control element (CE). In some embodiments, the transmitted multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter;
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.

In some embodiments, network node 16 is configured to determine the first CSI-RS configuration of the multiple CSI-RS configurations to use for the WD based on at least one of a quantity of ports, a beam shape, a quantity of WDs supported by the network node, and an energy consumption by the network node. In some embodiments, network node 16 is configured to receive a measurement report from the WD, the measurement report being based on the first CSI-RS configuration.

In some embodiments, the single parameter and/or the at least one parameter comprises one or more of a numbers of ports, a density, a power control offset and a quasi-colocation (QCL) information. In some embodiments, the indication of the first CSI-RS configuration is transmitted to a group of WDs to switch the group of WDs from using the second CSI-RS configuration to using the first CSI-RS configuration. In some embodiments, the DCI indication is transmitted in a common search space. In some embodiments, the multiple CSI-RS configurations comprise the first CSI-RS configuration and a second CSI-RS configuration, the indication the indication of the first CSI-RS configuration being transmitted to the WD 22 to switch the WD 22 from using the second CSI-RS configuration to using the first CSI-RS configuration. In some embodiments, the second CSI-RS configuration being a default CSI-RS configuration.

FIG. 8 is a flowchart of an example process in a wireless device 22 according to some embodiments of the present disclosure. One or more Blocks and/or functions and/or methods performed by WD 22 may be performed by one or more elements of WD 22 such as by measurement unit 34 in processing circuitry 84, processor 86, radio interface 82, etc. The WD 22 is configured to receive (Block S140) multiple channel state information-reference signal (CSI-RS) configurations. The WD 22 is configured to receive (Block S142) an indication of a first CSI-RS configuration of the multiple CSI-RS configurations via at least one of a downlink control information (DCI) and a medium access control (MAC) control element (CE). The WD 22 is configured to as a result of the indication, perform (Block S144) a CSI-RS procedure using the first CSI-RS configuration.

In some embodiments, the multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter;
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.

In some embodiments, the WD 22 is configured to perform the CSI-RS procedure by performing measurements on at least one CSI-RS resource that is configured by the first CSI-RS configuration. In some embodiments, the WD 22 is configured to transmit a measurement report from the WD 22, the measurement report being based on the first CSI-RS configuration.

In some embodiments, the single parameter and/or the at least one parameter comprises one or more of a numbers of ports, a density, a power control offset and a quasi-colocation (QCL) information. In some embodiments, the indication of the first CSI-RS configuration is received by a group of WDs 22 to switch the group of WDs 22 from using the second CSI-RS configuration to using the first CSI-RS configuration. In some embodiments, the DCI indication is received in a common search space.

In some embodiments, the multiple CSI-RS configurations comprise the first CSI-RS configuration and a second CSI-RS configuration, the indication the indication of the first CSI-RS configuration being received by the WD 22 to switch the WD 22 from using the second CSI-RS configuration to using the first CSI-RS configuration. In some embodiments, the second CSI-RS configuration being a default CSI-RS configuration.

FIG. 9 is a flowchart of an example process (i.e., a method) in a network node 16 according to some embodiments of the present disclosure. One or more Blocks and/or functions and/or methods performed by the network node 16 may be performed by one or more elements of network node 16 such as by configuration unit 32 in processing circuitry 68, processor 70, and/or radio interface 62, etc. according to the example method. Network node 16 is configured, such as by configuration unit 32 in processing circuitry 68, processor 70, and/or radio interface 62, to determine (Block S146) a plurality of channel state information reference signal (CSI-RS) configurations, the determined plurality of CSI-RS configurations including at least a first CSI-RS configuration and a second CSI-RS configuration, the first and second CSI-RS configurations comprising different values for at least one parameter: determine (Block S148) one of the first CSI-RS configuration and the second CSI-RS configuration usable by the WD 22 to perform a CSI procedure, where the one of the first CSI-RS configuration and the second CSI-RS configuration is determined based on at least one condition; and transmit (Block S150), to the WD 22, an indication indicating the determined one of the first CSI-RS configuration and the second CSI-RS configuration, the indication being transmitted using at least one of physical communication layer signaling and media access control (MAC) layer signaling.

In some embodiments, the at least one parameter is associated with a CSI-RS resource, where each one of the first and second CSI-RS configurations has at least one CSI-RS resource value that is different.

In some other embodiments, the at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated, QCL, information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the transmitted indication triggers the WD 22 to at least one of: activate one of the first CSI-RS configuration and the second CSI-RS configuration to perform the CSI procedure: deactivate one of the first CSI-RS configuration and the second CSI-RS configuration to perform the CSI procedure; switch from the first CSI-RS configuration to the second CSI-RS configuration to perform the CSI procedure; and switch from the second CSI-RS configuration to the first CSI-RS configuration to perform the CSI procedure.

In an embodiment, the method further includes: transmitting a CSI-RS based on the determined one of the first CSI-RS configuration and the second CSI-RS configuration; and receiving a CSI report as part of the CSI procedure. The CSI report includes at least one measurement based on the determined one of the first CSI-RS configuration and the second CSI-RS configuration.

In another embodiment, the at least one condition is associated with a port quantity, a beam shape, a quantity of WDs 22 supported by the network node 16, a power adaptation, a QCL parameter value, and an energy consumption by the network node 16.

In some embodiments, the at least one of the physical communication layer signaling and the MAC layer signaling includes at least one of downlink control information (DCI) and a MAC control element (CE); and/or the method further includes transmitting, via radio resource control signaling, at least the first and second CSI-RS configurations of the plurality of CSI-RS configurations to the WD 22 for the WD 22 to select one of the first and second CSI-RS configurations based at least in part on the transmitted indication.

FIG. 10 is a flowchart of an example process in a wireless device 22 according to some embodiments of the present disclosure. One or more Blocks and/or functions and/or methods performed by WD 22 may be performed by one or more elements of WD 22 such as by meas. Unit 34 in processing circuitry 84, processor 86, radio interface 82, etc. The WD 22 is configured, such as by meas. Unit 34 in processing circuitry 84, processor 86, radio interface 82, to receive (Block S154) an indication indicating one of a first channel state information reference signal (CSI-RS) configuration and a second CSI-RS configuration of a plurality of CSI-RS configurations. The first and second CSI-RS configurations are based on at least one condition and usable by the WD 22 to perform a CSI procedure. The first and second CSI-RS configurations include different values for at least one parameter. The indication is transmitted using at least one of physical communication layer signaling and media access control, MAC, layer signaling. The WD 22 is further configured, such as by measurement unit 34 in processing circuitry 84, processor 86, radio interface 82, to perform the CSI procedure based on one of the first CSI-RS configuration and the second CSI-RS configuration. In some embodiments, the at least one parameter is associated with a CSI-RS resource, where each one of the first and second CSI-RS configurations has at least one CSI-RS resource value that is different.

In some other embodiments, the at least one parameter is included in a CSI-RS resource mapping information element and includes at least one of a port number and a CSI-RS density.

In an embodiment, the at least one parameter is included in a non-zero power CSI-RS resource information element and includes at least one of a power control offset to a CSI-RS and a quasi-collocated (QCL) information.

In another embodiment, the at least one parameter is associated with a plurality of CSI-RS resources.

In some embodiments, the at least one parameter is associated with a plurality of CSI-RS resource sets, where each CSI-RS set of the plurality of CSI-RS resource sets corresponds to an index included in the indication.

In some other embodiments, the method further includes, based on the received indication: activating one of the first CSI-RS configuration and the second CSI-RS configuration to perform the CSI procedure: deactivating one of the first CSI-RS configuration and the second CSI-RS configuration to perform the CSI procedure; switching from the first CSI-RS configuration to the second CSI-RS configuration to perform the CSI procedure; and switching from the second CSI-RS configuration to the first CSI-RS configuration to perform the CSI procedure.

In an embodiment, the method further includes receiving a CSI-RS based on the one of the first CSI-RS configuration and the second CSI-RS configuration: performing at least one measurement based on one of the first CSI-RS configuration and the second CSI-RS configuration: determining CSI report as part of the CSI procedure, the CSI report including the at least one measurement; and transmitting the CSI report.

In another embodiment, the at least one condition is associated with a port quantity, a beam shape, a quantity of WDs 22 supported by the network node 16, a power adaptation, a QCL parameter value, and an energy consumption by the network node 16.

In some embodiments, the at least one of the physical communication layer signaling and the MAC layer signaling includes at least one of downlink control information (DCI) and a MAC control element (CE); and/or the method further includes receiving, via radio resource control signaling, at least the first and second CSI-RS configurations of the plurality of CSI-RS configurations to the WD 22; and/or selecting one of the received first and second CSI-RS configurations based at least in part on the received indication to perform the CSI procedure.

Having described the general process flow of arrangements of the disclosure and having provided examples of hardware and software arrangements for implementing the processes and functions of the disclosure, the sections below provide details and examples of arrangements for CSI-RS enhancements for NR WD, which may be implemented by the network node 16, wireless device 22 and/or host computer 24. One or more network node 16 functions described below may be performed by one or more of processing circuitry 68, processor 70, configuration unit 32, radio interface 62, etc. One or more WD 22/UE 22 functions may be performed by one or more of processing circuitry 84, processor 86, measurement unit 34, radio interface 82, etc.

In some embodiments, it may be assumed that the WD 22 is configured with more than one CSI-RS configuration. Some embodiments aim to provide a fast dynamic adaptation mechanism, in which the WD 22 can be indicated to switch between different CSI-RS configurations. The switching, can be for example, done by the NW such as via network node (NN) 16 during the port adaptation, i.e., where the NN 16 determines to change the quantity of ports that will be used to serve the respective WD 22.

Note that throughout the present disclosure, the term “multiple CSI-RS configurations” may refer to multiple CSI-RS configurations that can be activated/deactivated or switched through MAC-CE or DCI signaling, i.e., it is different existing CSI-RS configurations, in which multiple CSI-RS configurations are added or released through RRC (re) configuration.

In one example, the bitfield in the DCI can indicate if the default configuration or another one is activated. For example, the WD 22 may be configured with a first CSI-RS configuration and a second CSI-RS configuration with the first one as the default. An additional bit in the DCI, e.g., DCI 1-1/2 can be configured where if the bit status is “1”, the WD 22 receives the bit and thereby considers the second CSI-RS configuration as activated and the default one as deactivated. A bit “0” can be considered as reserved, or that the WD 22 should consider the default CSI-RS configuration as the active one.

In the aspects below, when the multiple CSI-RS configurations are not set for the WD 22, a legacy behavior may apply. For example, the WD 22 may monitor all of the CSI-RS, which are included in, e.g., CSI-MeasConfig. In another example, the additional bitfield in the DCI used for adaptation indication may not be included in the DCI transmitted to the WD 22.

### Multiple Configurations in a CSI-RS Resource

In one embodiment of the present disclosure, the WD 22 may be configured by the NN 16 to have more than one parameter configuration, e.g., parameters inside the CSI-RS-ResourceMapping Information Element (IE).

### Multiple Numbers of Ports

In one example, the WD 22 may be configured with the multiple nrofPorts parameter inside the CSI-RS-ResourceMapping IE. The first configured nrofPorts can act as the default nrofPorts of the respected CSI-RS-ResourceMapping (e.g., the parameter then can, for example, be renamed to nrofPortsDefault). The WD 22 then may be configured with the second, third, etc., additional nrofPorts parameter (e.g., the new parameter can be named with nrofPortsB, nrofPortsC, etc.). The DCI, or MAC-CE can then be used by the NN 16 to indicate the WD 22 to switch between those parameters (e.g., the multiple numbers of ports configured in the CSI-RS-ResourceMapping IE for a CSI-RS resource).

### Multiple Densities

In another example, the WD 22 may be configured with multiple density in CSI-RS-ResourceMapping IE. The NN 16 may decide to have this multiple density configuration, for example, because the change of the quantity of port may require different CSI-RS density within resource block.

### Modification to Existing RRC Configuration

### CSI-RS-ResourceMapping IE

An example describing how to put the above additional configurations to the RRC configuration can be seen below. In this example, the WD 22 may be configured with two parameters related to the quantity of ports configuration and two parameters related to the CSI-RS density. As mentioned above, the WD 22 may be indicated through, e.g., MAC-CE or DCI to switch between those parameters.

| | |
|---|---|
| -- ASN1START | |
| -- TAG-CSI-RS-RESOURCEMAPPING-START | |
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |
| }, | |
| nrofPortsDefault | ENUMERATED {p1,p2,p4,p8,p12,p16,p24,p32}, |
| nrofPortsB | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) OPTIONAL, -- Need R |
| cdm-Type | ENUMERATED {noCDM, fd-CDM2, cdm4-FD2-TD2, |
| cdm8-FD2-TD4}, | |
| densityDefault | CHOICE { |
| dot5 | ENUMERATED {evenPRBs, oddPRBs}, |
| one | NULL, |
| three | NULL, |
| spare | NULL |
| }, | |
| densityB | CHOICE { |
| dot5 | ENUMERATED {evenPRBs, oddPRBs}, |
| one | NULL, |
| three | NULL, |
| spare | NULL |
| }, | |
| freqBand | CSI-Frequency Occupation, |
| ... | |
| } | |

-- TAG-CSI-RS-RESOURCEMAPPING-STOP
-- ASN1STOP

### NZP-CSI-RS-Resource IE

In yet another example, the multiple parameter configurations can also be set to the parameter inside the NZP-CSI-RS-Resource IE. For example, the NN 16 (e.g., gNB) may configure multiple powercontroloffsetSS parameters. Having this flexibility, the NN 16 may, for example, apply a lesser powercontroloffsetSS to the CSI-RS with a first port configuration; and a larger powercontroloffsetSS to the CSI-RS with the second port configuration. This can be beneficial, for example, when the NN 16 knows the location of WDs 22 in reference to a cell (and may thereby only provide enough powercontroloffsetSS with optimal power to serve the WDs 22). In another example, a lesser powercontroloffsetSS can also be activated if the NN 16 knows that there are currently no WDs 22 in the cell.

Similarly, the NN 16 may also configure the WD 22 with multiple settings of qcl-InfoPeriodicCSI-RS, e.g., to accommodate the fact that the QCL type may change when port adaptation is performed, i.e., different QCL type may be configured for different port configurations.

Below is an example of a WD 22 configured with multiple powercontroloffsetSS parameters and multiple qcl-InfoPeriodicCSI-RS parameters inside an NZP-CSI-RS-Resource IE. In the example below, two different configurations may be configured for each powercontroloffsetSS and qcl-InfoPeriodicCSI-RS, where the first parameter is set to be the default configuration. More than two configurations for each parameter may also be used.

-- ASNISTART
-- TAG-NZP-CSI-RS-RESOURCE-START

| | |
|---|---|
| NZP-CSI-RS-Resource ::= | SEQUENCE { |
| nzp-CSI-RS-ResourceId | , |
| resourceMapping | CSI-RS-ResourceMapping, |
| powerControlOffset | INTEGER (−8..15), |
| powerControlOffsetSSDefault | ENUMERATED {db-3, db0, db3, db6} |

| | |
|---|---|
| OPTIONAL, | -- Need R |

| | |
|---|---|
| powerControlOffsetSS_B | ENUMERATED {db-3, db0, db3, db6} |

| | |
|---|---|
| OPTIONAL, | -- Need R |

| | |
|---|---|
| scramblingID | , |
| periodicity AndOffset | CSI-ResourcePeriodicity AndOffset |

| | |
|---|---|
| OPTIONAL, | -- Cond PeriodicOrSemiPersistent |

| | | |
|---|---|---|
| qcl-InfoPeriodicCSI-RSDefault | TCI-StateId | OPTIONAL, |

-- Cond Periodic

| | |
|---|---|
| qcl-InfoPeriodicCSI-RS_B | TCI-StateId |

| | |
|---|---|
| OPTIONAL, | -- Cond Periodic |

}
-- TAG-NZP-CSI-RS-RESOURCE-STOP
-- ASN1STOP

In another embodiment, multiple CSI-RS configurations inside an NZP-CSI-RS-Resource can also be obtained by having the multiple configured values for at least one parameter. In one example, the parameter nrofPorts can be set to have more than one values, e.g., instead of having one enumerated value. Having this feature, the NN 16 may then be able to configure the WD 22 with, e.g., 2 values of nrofPorts, e.g., p2, p8. An L1/L2 signalling, e.g., DCI or MAC-CE, then can be used to switch from p2 to p8 and vice versa.

Note that in the above description, the example only covers the nrofPorts, density, qcl-InfoPeriodicCSI-RS, and powercontroloffsetSS. However, this should not limit the implementation of the present disclosure to other types of CSI-RS configurations and/or configuration parameters.

### Multiple Configurations Via Multiple CSI-RS Resources

Multiple CSI-RS configurations can also be obtained by setting up multiple CSI-RS resources, in which each of the CSI-RS resource differs in at least one parameter configuration. While, setting multiple CSI-RS resources in the RRC configuration can already be performed in the current standard, the configuration does not allow a dynamic adaptation, e.g., switch the configuration through MAC-CE or DCI.

In another embodiment, the NN 16 may provide multiple NZP-CSI-RS-Resources that can be activated or deactivated using DCI or MAC CE. For example, there may be a default NZP-CSI-RS-Resource for default port configuration. If a change of port configuration is, or will be, performed, then another NZP-CSI-RS-Resource may be activated altogether in relation to the new port configuration (e.g., rather than merely having a CSI-RS resource configuration with multiple different parameters of the same kind or different potential values configured for the same parameter, as described above). An example of the NZP-CSI-RS-ResourceSet with multiple CSI-RS resources configured to the WD 22 is set forth below.

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-ResourcesDefault | SEQUENCE (SIZE (1..maxNrofNZP-CSI-RS- |

ResourcesPerSet)) OF NZP-CSI-RS-ResourceId,

| | |
|---|---|
| nzp-CSI-RS-ResourcesB | SEQUENCE (SIZE (1..maxNrofNZP- |

CSI-RS-ResourcesPerSet)) OF NZP-CSI-RS-ResourceId,

| | |
|---|---|
| repetition | ENUMERATED { on, off } |

| | |
|---|---|
| OPTIONAL, | -- Need S |

| | |
|---|---|
| aperiodicTriggeringOffset | INTEGER(0..6) |

| | |
|---|---|
| OPTIONAL, | -- Need S |

| | |
|---|---|
| trs-Info | ENUMERATED {true} |

| | |
|---|---|
| OPTIONAL, | -- Need R |

```
  . . .,
  [[
```

| | |
|---|---|
| aperiodicTriggeringOffset-r16 | INTEGER(0..31) |

| | |
|---|---|
| OPTIONAL | -- Need S |

]]
}
-- TAG-NZP-CSI-RS-RESOURCESET-STOP
-- ASN1STOP

### Multiple Configurations Via Multiple CSI-RS Resource Sets

In another embodiment, the multiple CSI-RS configurations may also be achieved by configuring the WD 22 with multiple CSI-RS resource sets. An additional parameter, e.g., nzp-CSI-ResourceSetSwitchingIndex can be introduced to each CSI-RS resource set configuration, e.g., to accommodate the activation/deactivation or switching mechanism. The indication, e.g., in the MAC-CE or DCI can then be used to point which index should be active at a time. For example, the first CSI-RS resource set may be configured with nzp-CSI-ResourceSetSwitchingIndex 0 and the second CSI-RS resource set may be configured with nzp-CSI-ResourceSetSwitchingIndex 1. When the indication, e.g., in the DCI, indicates switching index of 0 in the switching bitfield, the first CSI-RS resource set should be used by the WD 22 to, e.g., perform the measurement. On the other hand, when the indication indicates a switching index of 1 in the switching bitfield, the second CSI-RS resource set should be used by the WD 22 to e.g., perform the measurement. Although two example values of a switching index are used, more than the two example values of the switching index may also be supported/used.

Note that in the above approach, multiple CSI-RS resource sets may have the same value of nzp-CSI-ResourceSetSwitchingIndex. In such case, when the WD 22 is indicated with a certain switching index value, e.g., in the switching index bitfield in the DCI, all CSI-RS resource sets configured with the indicated value may be used by the WD 22 to perform measurements.

An example of this approach is shown below.

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |

| | |
|---|---|
| OPTIONAL, | -- Need S |

| | |
|---|---|
| aperiodicTriggeringOffset | INTEGER(0..6) |

| | |
|---|---|
| OPTIONAL, | -- Need S |

| | |
|---|---|
| trs-Info | ENUMERATED {true} |

| | |
|---|---|
| OPTIONAL, | -- Need R |

```
  ...,
  [[
```

| | |
|---|---|
| aperiodicTriggeringOffset-r16 | INTEGER(0..31) |

| | |
|---|---|
| OPTIONAL | -- Need S |

]]

| | |
|---|---|
| nzp-CSI-ResourceSetSwitchingIndex | INTEGER (0, 1), |

}
-- TAG-NZP-CSI-RS-RESOURCESET-STOP
-- ASN1STOP

Although some examples described above may include that the DCI be used to signal a switch/activation/deactivation, it is understood that the MAC-CE may be used in alternative embodiments to signal a switch/activation/deactivation in the multiple CSI-RS configurations. Signaling/resources, other than DCI and/or MAC-CE may also be used.

### Examples of the Procedures

By configuring the WD 22 with multiple CSI-RS configurations that can be activated/deactivated or switched (through MAC-CE or DCI), the NN 16 may have flexibility on which CSI-RS should be used at one time instance. The active CSI-RS configurations can be selected by the NN 16 based on, e.g., the state of the port adaptation. For example, the following mechanism can be used by the NN 16 to exploit the multiple CSI-RS configurations.
1. Configuring the WD 22 with multiple CSI-RS configurations (e.g., the multiple CSI-RS configurations can be obtained by one of the several approaches mentioned above).
2. Indicating to the WD 22 to switch from the first CSI-RS configuration to the second CSI-RS configuration.

The NN 16 may decide to change the CSI-RS configuration, for example, when there is no more WDs 22 active in the cell, and/or no WDs 22 are active that require and/or can take advantage of transmission with a large quantity of ports, e.g., sustained transmission with multiple layers and narrow beams. The NN 16 may decide to switch from the first CSI-RS configuration suitable for a larger quantity of ports transmission to the second CSI-RS configuration suitable for a smaller quantity of ports transmission. As described above, the indication can be done, e.g., via DCI or MAC-CE.
3. After sending the switching indication, the NN 16 may then transmit the CSI-RS according to the second CSI-RS configuration.

The NN 16 can configure the WD 22 through higher layer signaling e.g., RRC signaling if the activation/deactivation mechanism is DCI based and/or MAC CE based. The NN 16 may also configured WD 22 with the underlying configuration, e.g., bitfield and its interpretation in the DCI. The WD 22 can be pre-configured/defined, e.g., as in standardization documentations. For example, if there are two fields configured for a parameter, e.g., quantity of ports, the WD 22 automatically expects a MAC CE or DCI to be able to activate or deactivate the configurations.

On the WD 22 side, the WD 22 may receive a first CSI-RS configuration and a second CSI-RS configuration according to the example embodiments described in the present disclosure, e.g., through RRC signaling. The WD 22 then may start measuring or reporting based on the first configuration as the default configuration, and in one time instant, the WD 22 may receive a MAC CE command or a DCI indicating that the WD 22 should perform measurements or reporting based on the second configuration. The WD 22 may measure the CSI-RS based on the second configuration or report CSI based on measuring the second CSI-RS configuration.

In one embodiment, a group of WDs 22 may receive command to switch to a second configuration. This may, for example, be implemented as a group MAC or a DCI using group common search space. A group of WDs 22 can be configured to, using low signaling overhead and low latency, switch CSI-RS configurations. The individual CSI-RS configurations may still be configured per WD 22. The group switching command may be formulated as one or more of:
all WDs 22 in a group switch to a specific configuration index, e.g., switch to nzp-CSI-RS-ResourcesDefault or nzp-CSI-RS-ResourcesB; and/or
all WDs 22 in a group switch to an implicitly indicated configuration, e.g., switch to CSI-RS configuration with shortest periodicity, densest allocation in time/frequency, largest quantity of ports, etc.

The following is a nonlimiting list of example embodiments:
Embodiment A1. A network node configured to communicate with a user equipment (WD), the network node configured to, and/or comprising a radio interface and/or comprising processing circuitry configured to:
transmit multiple channel state information-reference signal (CSI-RS) configurations to the WD;
determine to use a first CSI-RS configuration of the multiple CSI-RS configurations for the WD; and
indicate the first CSI-RS configuration to the WD via at least one of a downlink control information (DCI) and a medium access control (MAC) control element (CE).
Embodiment A2. The network node of Embodiment A1, wherein the transmitted multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter;
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.
Embodiment A3. The network node of any one of Embodiments A1 and A2, wherein the network node and/or the radio interface and/or the processing circuitry is configured to one or more of:
determine the first CSI-RS configuration of the multiple CSI-RS configurations to use for the WD based on at least one of a number of ports, a beam shape, a number of WDs supported by the network node, and an energy consumption by the network node; and
receive a measurement report from the WD, the measurement report being based on the first CSI-RS configuration.
Embodiment A4. The network node of any one of Embodiments A1-A3, wherein the single parameter and/or the at least one parameter comprises one or more of a numbers of ports, a density, a power control offset and a quasi-colocation (QCL) information.
Embodiment A5. The network node of any one of Embodiments A1-A4, wherein one or more of:
the indication of the first CSI-RS configuration is transmitted to a group of WDs to switch the group of WDs from using the second CSI-RS configuration to using the first CSI-RS configuration; and/or
the DCI indication is transmitted in a common search space.
Embodiment A6. The network node of any one of Embodiments A1-A4, wherein one or more of:
the multiple CSI-RS configurations comprise the first CSI-RS configuration and a second CSI-RS configuration, the indication the indication of the first CSI-RS configuration being transmitted to the WD to switch the WD from using the second CSI-RS configuration to using the first CSI-RS configuration; and/or
the second CSI-RS configuration being a default CSI-RS configuration.
Embodiment B1. A method implemented in a network node, the method comprising:
transmitting multiple channel state information-reference signal (CSI-RS) configurations to a WD;
determining to use a first CSI-RS configuration of the multiple CSI-RS configurations for the WD; and
indicating the first CSI-RS configuration to the WD via at least one of a downlink control information (DCI) and a medium access control (MAC) control element (CE).
Embodiment B2. The method of Embodiment B1, wherein the transmitted multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter;
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.
Embodiment B3. The method of any one of Embodiments B1 and B2, further comprising one or more of:
determining the first CSI-RS configuration of the multiple CSI-RS configurations to use for the WD based on at least one of a number of ports, a beam shape, a number of WDs supported by the network node, and an energy consumption by the network node; and
receiving a measurement report from the WD, the measurement report being based on the first CSI-RS configuration.
Embodiment B4. The method of any one of Embodiments B1-B3, wherein the single parameter and/or the at least one parameter comprises one or more of a numbers of ports, a density, a power control offset and a quasi-colocation (QCL) information.
Embodiment B5. The method of any one of Embodiments B1-B4, wherein one or more of:
the indication of the first CSI-RS configuration is transmitted to a group of WDs to switch the group of WDs from using the second CSI-RS configuration to using the first CSI-RS configuration; and/or
the DCI indication is transmitted in a common search space.
Embodiment B6. The method of any one of Embodiments B1-B4, wherein one or more of:
the multiple CSI-RS configurations comprise the first CSI-RS configuration and a second CSI-RS configuration, the indication the indication of the first CSI-RS configuration being transmitted to the WD to switch the WD from using the second CSI-RS configuration to using the first CSI-RS configuration; and/or
the second CSI-RS configuration being a default CSI-RS configuration.
Embodiment C1. A user equipment (WD) configured to communicate with a network node, the WD configured to, and/or comprising a radio interface and/or processing circuitry configured to:
receive multiple channel state information-reference signal (CSI-RS) configurations:
receive an indication of a first CSI-RS configuration of the multiple CSI-RS configurations via at least one of a downlink control information (DCI) and a medium access control (MAC) control element (CE); and
as a result of the indication, perform a CSI-RS procedure using the first CSI-RS configuration.
Embodiment C2. The WD of Embodiment C1, wherein the multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter:
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.
Embodiment C3. The WD of any one of Embodiments C1 and C2, wherein the WD and/or the radio interface and/or the processing circuitry is configured to one or more of:
perform the CSI-RS procedure by performing measurements on at least one CSI-RS resource that is configured by the first CSI-RS configuration; and/or
transmit a measurement report from the WD, the measurement report being based on the first CSI-RS configuration.
Embodiment C4. The WD of any one of Embodiments C1-C3, wherein the single parameter and/or the at least one parameter comprises one or more of a numbers of ports, a density, a power control offset and a quasi-colocation (QCL) information.
Embodiment C5. The WD of any one of Embodiments C1-C4, wherein one or more of:
the indication of the first CSI-RS configuration is received by a group of WDs to switch the group of WDs from using the second CSI-RS configuration to using the first CSI-RS configuration; and/or
the DCI indication is received in a common search space.
Embodiment C6. The WD of any one of Embodiments C1-C4, wherein one or more of:
the multiple CSI-RS configurations comprise the first CSI-RS configuration and a second CSI-RS configuration, the indication the indication of the first CSI-RS configuration being received by the WD to switch the WD from using the second CSI-RS configuration to using the first CSI-RS configuration; and/or
the second CSI-RS configuration being a default CSI-RS configuration.
Embodiment D1. A method implemented in a user equipment (WD), the method comprising:
receiving multiple channel state information-reference signal (CSI-RS) configurations:
receiving an indication of a first CSI-RS configuration of the multiple CSI-RS configurations via at least one of a downlink control information (DCI) and a medium access control (MAC) control element (CE); and
as a result of the indication, performing a CSI-RS procedure using the first CSI-RS configuration.
Embodiment D2. The method of Embodiment D1, wherein the multiple CSI-RS configurations comprise one of:
a configuration of a CSI-RS resource, the configuration of the CSI-RS resource comprising multiple different configurations/values for a single parameter, the first CSI-RS configuration corresponding to one of the values for the single parameter:
multiple configurations of CSI-RS resources, each configuration of a respective CSI-RS resource comprising a different value for at least one parameter, the first CSI-RS configuration corresponding to the CSI-RS resource comprising one of the values for the at least one parameter; and
multiple configurations of CSI-RS resource sets, each configuration of a respective CSI-RS resource set comprising a different value for at least one parameter, the first CSI-RS configuration corresponding to the CSI-RS resource set comprising one of the values for the at least one parameter.
Embodiment D3. The method of any one of Embodiments D1 and D2, further comprising one or more of:
performing the CSI-RS procedure by performing measurements on at least one CSI-RS resource that is configured by the first CSI-RS configuration; and/or
transmitting a measurement report from the WD, the measurement report being based on the first CSI-RS configuration.
Embodiment D4. The method of any one of Embodiments D1-D3, wherein the single parameter and/or the at least one parameter comprises one or more of a numbers of ports, a density, a power control offset and a quasi-colocation (QCL) information.
Embodiment D5. The method of any one of Embodiments D1-D4, wherein one or more of:
the indication of the first CSI-RS configuration is received by a group of WDs to switch the group of WDs from using the second CSI-RS configuration to using the first CSI-RS configuration; and/or
the DCI indication is received in a common search space.
Embodiment D6. The method of any one of Embodiments D1-D4, wherein one or more of:
the multiple CSI-RS configurations comprise the first CSI-RS configuration and a second CSI-RS configuration, the indication the indication of the first CSI-RS configuration being received by the WD to switch the WD from using the second CSI-RS configuration to using the first CSI-RS configuration; and/or
the second CSI-RS configuration being a default CSI-RS configuration.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
processing circuitry configured to:
determine a plurality of channel state information reference signal, CSI-RS, configurations, the determined plurality of CSI-RS configurations including at least a first CSI-RS configuration and a second CSI-RS configuration, the first and second CSI-RS configurations comprising different values for at least one parameter;
determine one of the first CSI-RS configuration and the second CSI-RS configuration usable by the WD to perform a CSI procedure, the one of the first CSI-RS configuration and the second CSI-RS configuration being determined based on at least one condition; and
a radio interface in communication with the processing circuitry, the radio interface being configured to:
transmit, to the WD, an indication indicating the determined one of the first CSI-RS configuration and the second CSI-RS configuration, the indication being transmitted using at least one of physical communication layer signaling and media access control, MAC, layer signaling.

2.-10. (canceled)

11. A method in a network node configured to communicate with a wireless device, WD, the method comprising:
determining a plurality of channel state information reference signal, CSI-RS, configurations, the determined plurality of CSI-RS configurations including at least a first CSI-RS configuration and a second CSI-RS configuration, the first and second CSI-RS configurations comprising different values for at least one parameter;
determining one of the first CSI-RS configuration and the second CSI-RS configuration usable by the WD to perform a CSI procedure, the one of the first CSI-RS configuration and the second CSI-RS configuration being determined based on at least one condition; and
transmitting, to the WD, an indication indicating the determined one of the first CSI-RS configuration and the second CSI-RS configuration, the indication being transmitted using at least one of physical communication layer signaling and media access control, MAC, layer signaling.

12. The method of claim 11, wherein the at least one parameter is associated with a CSI-RS resource, each one of the first and second CSI-RS configurations having at least one CSI-RS resource value that is different.

13. The method of claim 12, wherein the at least one parameter is included in a CSI-RS resource mapping information element and includes at least one of:
a port number; and
a CSI-RS density.

14. The method of claim 12, wherein the at least one parameter is included in a non-zero power CSI-RS resource information element and includes at least one of:
a power control offset to a CSI-RS; and
a quasi-collocated, QCL, information.

15. The method of claim 11, wherein the at least one parameter is associated with a plurality of CSI-RS resources.

16. The method of claim 11, wherein the at least one parameter is associated with a plurality of CSI-RS resource sets, each CSI-RS set of the plurality of CSI-RS resource sets corresponding to an index included in the indication.

17. The method of claim 11, wherein the transmitted indication triggers the WD to at least one of:
activate one of the first CSI-RS configuration and the second CSI-RS configuration to perform the CSI procedure;
deactivate one of the first CSI-RS configuration and the second CSI-RS configuration to perform the CSI procedure;
switch from the first CSI-RS configuration to the second CSI-RS configuration to perform the CSI procedure; and
switch from the second CSI-RS configuration to the first CSI-RS configuration to perform the CSI procedure.

18. The method of claim 11, wherein the method further includes:
transmitting a CSI-RS based on the determined one of the first CSI-RS configuration and the second CSI-RS configuration; and
receiving a CSI report as part of the CSI procedure, the CSI report including at least one measurement based on the determined one of the first CSI-RS configuration and the second CSI-RS configuration.

19. The method of claim 11, wherein the at least one condition is associated with a port quantity, a beam shape, a quantity of WDs supported by the network node, a power adaptation, a QCL parameter value, and an energy consumption by the network node.

20. The method of claim 11, wherein at least one of:
the at least one of the physical communication layer signaling and the MAC layer signaling includes at least one of downlink control information, DCI, and a MAC control element, CE; and
the method further includes:
transmitting, via radio resource control signaling, at least the first and second CSI-RS configurations of the plurality of CSI-RS configurations to the WD for the WD to select one of the first and second CSI-RS configurations based at least in part on the transmitted indication.

21. A wireless device, WD, configured to communicate with a network node, the WD comprising:
a radio interface configured to:
receive an indication indicating one of a first channel state information reference signal, CSI-RS, configuration and a second CSI-RS configuration of a plurality of CSI-RS configurations, the first and second CSI-RS configurations being based on at least one condition and usable by the WD to perform a CSI procedure, the first and second CSI-RS configurations comprising different values for at least one parameter, the indication being transmitted using at least one of physical communication layer signaling and media access control, MAC, layer signaling; and
processing circuitry in communication with the radio interface, the processing circuitry being configured to:
perform the CSI procedure based on one of the first CSI-RS configuration and the second CSI-RS configuration.

22.-30. (canceled)

31. A method in a wireless device, WD, configured to communicate with a network node, the method comprising:
receiving an indication indicating one of a first channel state information reference signal, CSI-RS, configuration and a second CSI-RS configuration of a plurality of CSI-RS configurations, the first and second CSI-RS configurations being based on at least one condition and usable by the WD to perform a CSI procedure, the first and second CSI-RS configurations comprising different values for at least one parameter, the indication being transmitted using at least one of physical communication layer signaling and media access control, MAC, layer signaling; and
performing the CSI procedure based on one of the first CSI-RS configuration and the second CSI-RS configuration.

32. The method of claim 31, wherein the at least one parameter is associated with a CSI-RS resource, each one of the first and second CSI-RS configurations having at least one CSI-RS resource value that is different.

33. The method of claim 32, wherein:
the at least one parameter is included in a CSI-RS resource mapping information element and includes at least one of:
a port number; and
a CSI-RS density; and
the at least one parameter is included in a non-zero power CSI-RS resource information element and includes at least one of:
a power control offset to a CSI-RS; and
a quasi-collocated, QCL, information.

34. (canceled)

35. (canceled)

36. The method of claim 31, wherein the at least one parameter is associated with a plurality of CSI-RS resource sets, each CSI-RS set of the plurality of CSI-RS resource sets corresponding to an index included in the indication.

37. The method of claim 31, wherein the method further includes, based on the received indication:
activating one of the first CSI-RS configuration and the second CSI-RS configuration to perform the CSI procedure;
deactivating one of the first CSI-RS configuration and the second CSI-RS configuration to perform the CSI procedure;
switching from the first CSI-RS configuration to the second CSI-RS configuration to perform the CSI procedure; and
switching from the second CSI-RS configuration to the first CSI-RS configuration to perform the CSI procedure.

38. The method of claim 31, wherein the method further includes:
receiving a CSI-RS based on the one of the first CSI-RS configuration and the second CSI-RS configuration;
performing at least one measurement based on one of the first CSI-RS configuration and the second CSI-RS configuration;
determining CSI report as part of the CSI procedure, the CSI report including the at least one measurement; and
transmitting the CSI report.

39. The method of claim 31, wherein the at least one condition is associated with a port quantity, a beam shape, a quantity of WDs supported by the network node, a power adaptation, a QCL parameter value, and an energy consumption by the network node.

40. The method of claim 31, wherein at least one of:
the at least one of the physical communication layer signaling and the MAC layer signaling includes at least one of downlink control information, DCI, and a MAC control element, CE;
the method further includes:
receiving, via radio resource control signaling, at least the first and second CSI-RS configurations of the plurality of CSI-RS configurations to the WD; and
selecting one of the received first and second CSI-RS configurations based at least in part on the received indication to perform the CSI procedure.
